(19) United States
(12) Patent Application Publication
(10) Pub. No.: US 2007/0247768 A1
(43) Pub. Date: Oct. 25, 2007

(54) Wireless handheld device and circuit breaker

(75) Inventors: Steven M. Meehleder, Cedar Rapids, IA (US); Roger L. Wolf, Lisbon, IA (US)

Correspondence Address: SCHNEIDER ELECTRIC / SQUARE D COMPANY;LEGAL DEPT. - I.P. GROUP, 1415 S. ROSELLE ROAD, PALATINE, IL, 60067, US

(73) Assignee: Square D Company

(21) Appl. No.: 11/409,245

(22) Filed: Apr. 21, 2006

(51) Int. Cl. H02H 9/08

(52) U.S. Cl. 361/42; 340/10.1

(57) ABSTRACT

A system is provided for enabling the communication between a handheld device 26 and a circuit breaker (18a, 18b, 18c). The system comprises an electronic circuit breaker (18a, 18b, 18c) including an RFID component (54) having an RFID module (56) for storing data and a microcontroller (50) connected to the RFID module (56) and controlling the operation of the breaker (18a, 18b, 18c) in accordance with the data; and a handheld device (26) for communicating with the electronic circuit breaker (18a, 18b, 18c), the handheld device (26) including a microcontroller (50) controlling the operation of the handheld device (26) and a communicating component (82, 86) connected to the microcontroller (80) communicating wirelessly with the electronic circuit breaker (18a, 18b, 18c).

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

The present invention relates generally to electronic circuit breakers, and more specifically, to wireless communication with a circuit breaker.

In electrical distribution systems in which conventional industrial circuit breakers are connected, each breaker is designed, i.e., the breaker parameters are set to enable the breaker to do specific functions when used in the field. For example, one parameter is set to control the tripping function. That is, the setting enables the breaker to trip, i.e., to interrupt power when the current reaches the desired parameter value. Another parameter setting may control the time in which the breaker delays or waits to trip. All settings of the circuit breaker are initially established at the site of manufacture.

In a typical breaker, there are several (approximately 2-8) small rotary switches for displaying current setting values. The switches are visible through a plastic door. There are labels around each switch for viewing. The door is usually locked to prevent unauthorized access. The switches are designed to allow a service operator to manually change parameters/settings to control the operational characteristics of the breaker (e.g., tripping value). Each switch typically includes a number of small moving mechanical components that make predefined contacts to enable the internal microcontroller to accurately read the parameters. During normal operation, the breakers generate a 60 Hz hum, i.e., vibration. Because of this vibration, the switch components may not make the appropriate contacts. Consequently, the internal microcontroller may not accurately read the settings. In one example, the breaker may trip erroneously (i.e., nuisance trip) because of an inaccurate reading.

There are other disadvantages with conventional industrial circuit breakers including internal contamination and heat which may cause damage to the breaker. Specifically, many conventional circuit breakers include at least one communication terminal to enable access to the circuit board inside the breaker (for making changes to the components inside such as upgrading the firmware). Due to the seals between the terminals and breaker housing, pollution, dust and moisture bleed into the breaker causing damage to internal components (and premature replacement). Because industrial circuit breakers have decreased in size over the years to accommodate space and construction requirements (but not functions), a typical industrial circuit breaker experiences an enormous amount of heat within the breaker. Temperatures within a typical circuit breaker can reach as high as 100 degrees Centigrade. In some of the higher end circuit breakers, LCD displays are incorporated to view and scroll through a series of menus to view and set parameters. Temperatures in this range can greatly reduce the life of an LCD and various other components (and hence circuit breaker itself).

It would be beneficial if there existed a system, method or device that would overcome the disadvantages of the prior art.

### BRIEF DESCRIPTION OF THE INVENTION

In accordance with an embodiment of the present invention, a method is provided of communicating with an electronic circuit breaker. The method comprises the steps of electromagnetically coupling a handheld device with the circuit breaker for communication therebetween and accessing data stored within the circuit breaker.

In another embodiment of the invention, an electronic circuit breaker comprises an RFID component including an RFID module for storing data, and a microcontroller connected to the RFID component and controlling the operation of the breaker in accordance with the data.

In another embodiment, a handheld device for communicating with an electronic circuit breaker, the handheld device comprises a microcontroller controlling the operation of the handheld device and a communicating component connected to the microcontroller and communicating wirelessly with the electronic circuit breaker.

In yet another embodiment of the invention, a system for enabling the communication between a handheld device and a circuit breaker, the system comprises an electronic circuit breaker including an RFID component having an RFID module for storing data and a microcontroller connected to the RFID module and controlling the operation of the breaker in accordance with the data, and a handheld device for communicating with the electronic circuit breaker, the handheld device including a microcontroller controlling the operation of the handheld device and a communicating component connected to the microcontroller communicating wirelessly with the electronic circuit breaker.

### BRIEF DESCRIPTION OF THE DRAWINGS

The accompanying drawings, which are incorporated herein and constitute a part of the specification, illustrate a presently preferred embodiment of the invention, and together with the general description given above and the detailed description of the preferred embodiment given below, serve to explain the principals of the invention.

FIG. 1 is a schematic diagram illustrating an electrical distribution system incorporating several industrial electronic circuit breakers and a handheld device in accordance with a preferred embodiment of the present invention.

FIG. 2 is an enlarged detailed schematic diagram illustrating the handheld device communicating with the desired circuit breaker shown in FIG. 1.

FIG. 3 is a flowchart illustrating the communication process between the handheld device and the desired electronic circuit breaker shown in FIG. 1.

FIG. 4 is a flowchart illustrating the detailed steps of certain steps in the communication process shown in FIG. 3.

### DETAILED DESCRIPTION OF THE DRAWINGS

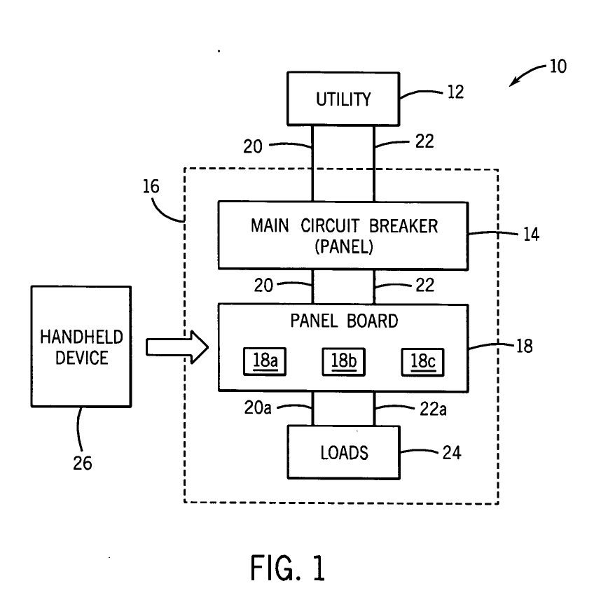

In FIG. 1, there is shown an industrial electrical power distribution system 10 in which electrical power from utility 12 is supplied to loads through main circuit breaker 14 (panel) via an electrical wiring system. The wiring system is merely the wiring within facility 16 that electrically connects the loads and the circuit breakers to utility 12 (power source). System 10 includes panel board 18 in which three adjacent electronic circuit breakers 18a, 18b, 18c (and main circuit breaker 14) are electrically connected to the wiring system. Three breakers are shown (not including main circuit breaker 14), but system 10 typically includes any number of circuit breakers. Each electronic circuit breaker is preferably capable of handling loads requiring up to 250 amps or more. Each electronic circuit breaker 18a, 18b, 18c is connected to utility 12 through main circuit breaker 14 by way of power line 20 and neutral line 22. Each breaker is connected between utility 12 and a load (as described below) to protect the electrical wiring system. While not shown in FIG. 1, power distribution 10 may include a switch box between utility 12 and facility 16 to enable multiple power line input to facility 16. In the event the primary power source fails for some external reason, switch box will switch to a secondary power source.

Power system 10 provides power to loads 24 via load line 20a. Loads 24 are electrically connected to panel board 18 (i.e., adjacent electronic circuit breakers 18a, 18b, 18c, respectively) via load power line 20a and load neutral lines 22a, respectively of the wiring system. As is known in the art, power line 20a is effectively power line 10 and neutral line 22a is the same as neutral line 22. References numerals 20a and 22a are used for purposes of clarity only. It is important to note that electrical power distribution system 10 is the preferred embodiment of the invention. System 10 may employ a single or multiple phase system.

A load is any device or plurality of devices that draw electrical current. A load can be a single device connected to an outlet (i.e., power) such as a manufacturing or printing machine, computer system, testing equipment, or multiple devices connected in parallel or multiple outlets. Each space of facility 16 typically has several electrical outlets for supplying current to loads 24.

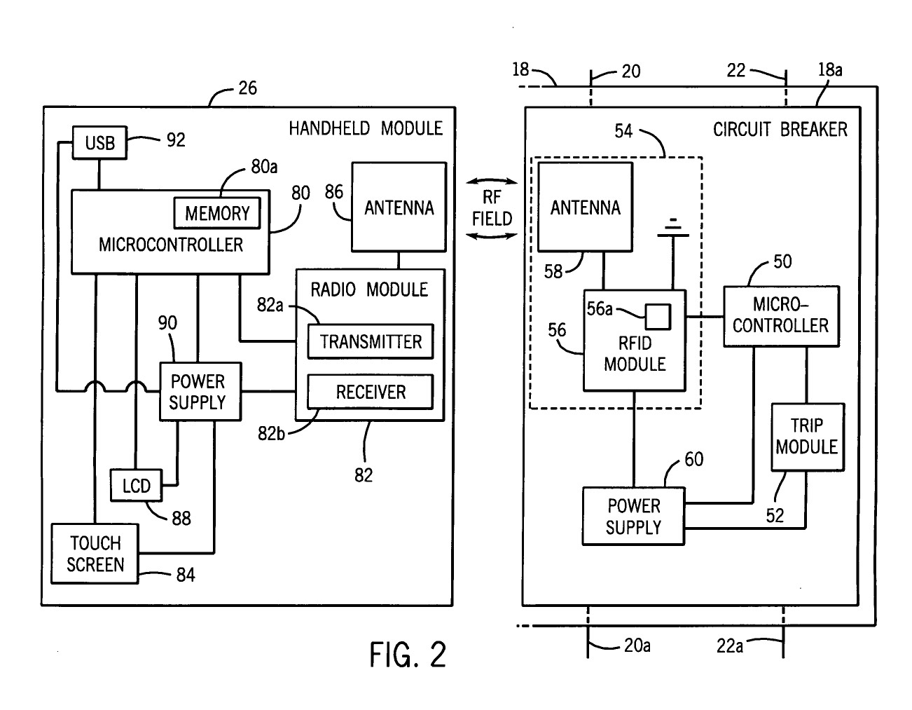

In FIG. 1, there is also shown handheld device 26 for communicating with a desired circuit breaker, i.e., breaker 18a within panel board 18. Handheld device 26 is described in more detail below with respect to FIG. 2.

Each electronic circuit breaker is appropriately connected to protect a portion of the electrical wiring system. In some cases, the portion of the electrical wiring system may be a single area within facility 16 with multiple outlets. Specifically, each breaker is designed to protect the components that use the current flowing from power line 20 to a particular load (24) from damage caused by electrical anomalies such as over current or under voltage conditions. A breaker provides protection by interrupting current, or removing power to the downstream loads when an electrical anomaly occurs. Each breaker includes a variety of components to perform this protection. These components are described below. It is also important to note that each circuit breaker is enclosed in an appropriate casing to comply with UL, CE (Europe) and CSA (Canada) standards. The casing is typically a water resistant metal casing. In the preferred embodiment described herein, the metal casing includes a nonmetal layer (or area) to allow electromagnetic coupling with handheld device 26, as discussed in detail below.

FIG. 2 illustrates an enlarged view of electronic circuit breaker 18a (desired breaker for communication). As previously mentioned, handheld device 26 is electromagnetically coupled to breaker 18a. As discussed below, coupling proximity is important to ensure proper communication between handheld device 26 and breaker 18a in accordance with invention. In the preferred embodiment, handheld device 26 may be attached directly to breaker 18a to ensure proper proximity (proper distance is described in detail below). Velcro strips are preferably used for this purpose and are attached to handheld 26 and breaker 18a. It is important to note that each breaker has the same components. For purposes of this discussion, however, only the components of breaker 18a will be described herein. Breaker 18a (like breakers 18b, 18c) is preferably fault powered. Consequently, no external power supply is required because power is derived from a current transformer within the breakers. As a result, data reading and writing from/to the RFID module (tag) is achieved if internal power breaker power is not available as discussed in more detail below.

In the preferred embodiment, electronic circuit breaker 18a (and all other breakers) is circuit breaker capable of industrial requirements, i.e., capable of operating within a 250 amp range to protect the associated electrical wiring and the components. Breaker 18a has a number of components including microcontroller 50 and trip module 52. Microcontroller 50 is preferably a self contained ASICS chip that includes memory for storing firmware. The memory within microcontroller 50 is a re-writable non-volatile memory such as EEPROM for storing the firmware. The firmware is typically loaded into the circuit breaker at the manufacturing site. The firmware is a software program that includes coded instructions and data parameters such as tripping and other values. Microcontroller 50 is designed to control the operation of the breaker in accordance with the firmware stored in memory. As one function, it monitors the current to instruct the trip module 52 when to trip.

Trip module 52 consists of electronic trip circuitry and electromechanical components as is known in the art including a solenoid/coil (not shown) and a power mosfet (not shown). The trip coil typically requires a high current so a power mosfet is used. The mosfet is driven by microcontroller 50. Under the control of the microcontroller 50, tripping module 52 is designed to effectuate timely tripping to protect the associated wiring and components. Specifically, microcontroller 50 will determine whether a signal satisfies the requirements to active the appropriate electromechanical components within module 52 (such as the solenoid) to mechanically open circuit breaker contacts to prevent further current from flowing in the associated wiring in the wiring system. Breaker 18a also includes other known components including a current transformer (not shown) connected conventionally along the power line and other conventional components.

Circuit breaker 18a further includes a radio frequency identification (“RFID”) system or component 54. Component 54 contains RFID module 56 connected to microcontroller 50 via an 12 C bus (Inter-IC bus, a bidirectional 2 wire bus) and antenna 58 connected to RFID module 56. RFID module 56 is also known as a transponder or RFID tag to those skilled in the art and it is used for communicating with handheld device 26. RFID module 56 and microcontroller 50 operate in a master-slave arrangement. In this arrangement, RFID module 56 strictly acts as a slave device under the control of the master, microcontroller 50. RFID module 56 includes memory 56a as well as a controller, antenna interface, and capacitor (three components not shown) connected between memory 56a and antenna 58. Antenna 58 is positioned adjacent an internal wall of breaker 18a to enable handheld device 26 to properly communicate wirelessly with breaker 18a as described in more detail below. Antenna 58 is preferably a coil connected across the capacitor (not shown). In the preferred embodiment, the RFID module 56 is an integrated circuit (IC). IC Chips made by ATMEL are suitable for this purpose.

Memory 56a within RFID module 56 is a non-volatile memory device for storing breaker settings/parameters data. For example, the tripping limits and tripping stepping rates are stored in memory 56a. Memory 56a is preferably an EEPROM, but could be any other storage device that permits reading and writing (programming). Data can be read or written (programming) to memory 56a. These settings/parameters are programmed within the RFID memory 56a (at the same time as the firmware is stored in microcontroller 50 memory) at the conclusion of production and will be subsequently read by microcontroller 50. Once memory 56a is programmed at the conclusion of production, the parameter limits within memory 56a cannot be changed. The settings/parameters can only be changed within the stored limits. That is, the parameters/settings may be chosen if such parameters are set and within the limits stored in memory 56a, as described in more detail below.

Suffice it to say, RFID memory 56a is designed to store parameter/setting data. Microcontroller 50 then reads and uses the parameters/settings for proper operation. Microcontroller 50 preferably reads parameters/settings stored in RFID module 56 every 3 seconds and updates microcontroller 50 registers. Note that the data within RFID module 56 is different from the data (firmware) stored in the EEPROM within microcontroller 50. No firmware data is transferred from RFID memory 56a to the internal EEPROM in microcontroller 56 to change the firmware program stored therein (and hence the general operation of the microcontroller 50). RFID module 56 is a passive RFID tag or transponder which may derive its power solely from radio waves of a specific frequency. RFID module 56 does not require a battery or external power source to enable reading and writing to the RFID module 56 (tag). In the preferred embodiment, RFID module 56 derives power from an RF signal and the power supply (whichever supplies the highest power up to 5 volts).

Circuit breaker 18a also includes power supply 60 that supplies DC power to trip module 52 and microcontroller 50 and RFID module 56 (to enable the microcontroller 50 to read the data from RFID module 56). Power supply 60 and other conventional components including a bridge rectifier (not shown) convert the AC waveform from power line 20 (connection not shown for clarity) to a DC waveform. This DC waveform is used to provide power to these components.

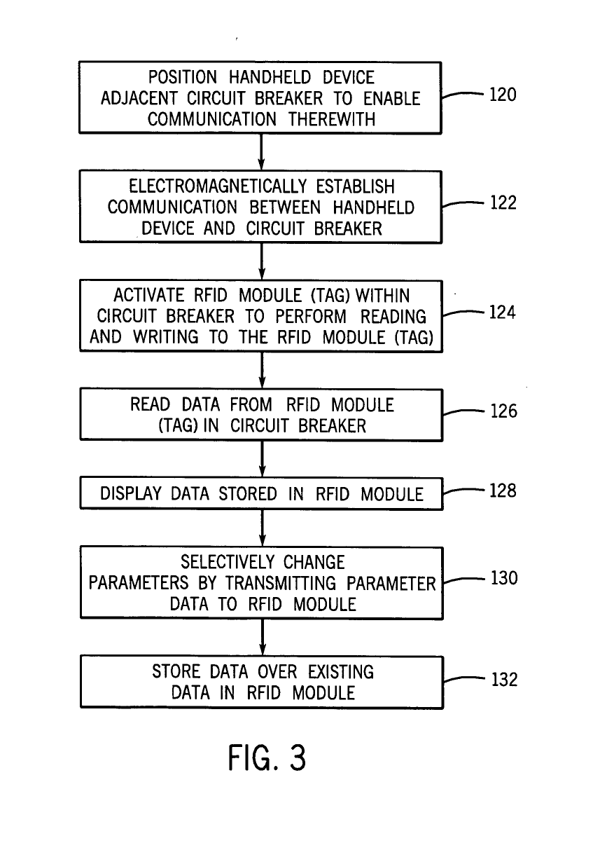

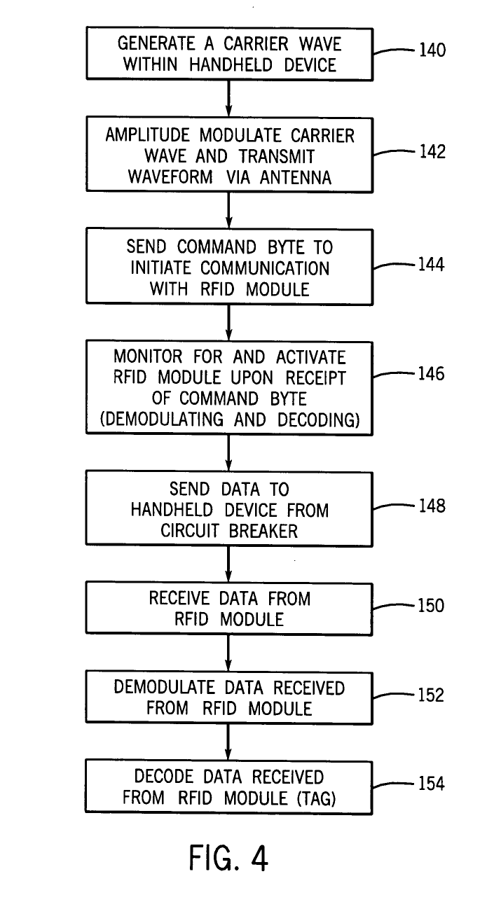

Also in FIG. 2, there is shown a detailed internal view of handheld device 26. Handheld device 26 includes a housing to seal against the outside environment. This housing is preferably a water resistant plastic casing to effectively seal the components inside and to but to enable communication between handheld 26 and breaker 26a as described in more detail below. Handheld device 26 includes microcontroller 80, radio module 82, touch screen module 84, antenna 86, and LCD 88. Microcontroller 80 is connected to and controls the operation of radio module 82, touch screen module 84 and LCD 88. Antenna 86 is properly positioned (preferably adjacent a wall of handheld 26) to enable communication with antenna 58 of breaker 18a. Antenna 86 is preferably a coil (1 inch diameter, 160 turn, 28 gauge), but may be another size coil or component for transmitting and receiving an RF signal. Microcontroller 80 includes a non-volatile memory that is preferably an EEPROM. The EEPROM stores the firmware program used by microcontroller 80 to control the general operation of handheld device 26 and also stores the parameter/setting data used to program memory 56a in breaker 18a. This operation will be described in more detail below with respect to FIGS. 3 and 4.

LCD 88 is preferably of the cholesteric (non-volatile) type (distributed by Kent Displays). That is, LCD 88 is designed to retain the image last written to it even when power is removed. LCD 88 is preferably a 4 line screen (Kent Displays PN 128×32×2.3−7) or alternatively a ⅛ VGA screen (Kent Displays PN 240×160×2.9). This size allows text or graphics to be displaced on LCD 88. LCD 88 is controlled by microcontroller 80 to display the text or graphics. Touch screen 84 (includes a controller chip not shown) is preferably of the conventional resistive type that converts a location (desired choice on LCD 88) into a number to be used by microcontroller 80. Alternatively, touch screen may be an area switch type. Touch screen 84 is essentially used in place of the switches incorporated in conventional breakers. In this respect, LCD 88 could provide an area representing interactive switches. Touch screen 84 may enable a user to display and select any number of menus and parameter/setting combinations. Such settings/parameters may include the trip level, trip delay times, instantaneous current, metering, full load current rating, overload pickup level, long time delay, long time delay (time to trip if load is 6 times full load current rating), and short time pickup (short circuit pickup with delay). Optional labels may be used on the touch screen to visibly define a menu or parameter/setting.

Radio module 82 consists of transmitter 82a and receiver 82b. These components are shown without internal connections. Transmitter 82a transmits an RF wave of specific frequency to active RFID module 56 (memory 56a) and to enable it to be read and programmed. Transmitter preferably includes a transistor to amplitude module the carrier wave generated by microcontroller 80. Receiver 82b includes an operational amplifier and other conventional discrete components (e.g., resistor and capacitor) to transform RF signals received from antenna 86 into microcontroller-compatible signals for microcontroller 80. Radio module 82 also preferably includes capacitors (not shown) and possibly other components to effectuate proper signal transmission and reception. Radio module 82 and the components within it are preferably incorporated in a single chip. Such chips are marketed by Atmel Corporation and other companies. Radio module 82 and antenna 86 are referred to individually and together as a communicating component.

In operation, microcontroller 80 generates a carrier waveform of specific frequency, and transmitter 82a modulates that waveform to send and receive data from RFID module 56. The preferred or specific frequency is 125 KHz. Low frequency (i.e., power) waves are employed to reduce or eliminate incidental activation and reprogramming of unintended adjacent breakers. In order to enable proper communication with RFID module or tag 56 (i.e., activation) using a low frequency signal, handheld device 26 must be placed in close proximity with antenna 58 of breaker 18a. Note that the carrier wave must be present at all times during reading and writing of RFID module 56 (tag). Receiver 82b functions to demodulate the data sent by RFID module 56. The data is then decoded by microcontroller 80 to obtain the stored information. The firmware stored in the EEPROM in the microcontroller 80 (firmware within EEPROM) is coded to check and recognize the software version in RFID tag 56.

Handheld device 26 also includes a power supply 90 and USB port 92, each connected to microcontroller 80. Power supply supplies DC power to several internal components including microcontroller 80, radio module 82, LCD 88, touch screen 84 and USB 92. Handheld device 26 preferably includes a 3 volt lithium cell that is stepped up by power supply 90 (DC-DC switching type) to 5 volts. It is important to note that the components in handheld device 26 are preferably of the type that draws little power to increase the life of the battery. In optimal circumstances, the battery may last 5 years with normal usage. USB port 92 is preferably used to connect handheld device 26 to a computer to enable the transfer (download) of data (breaker parameters/settings) from the computer to the memory or storage device within microcontroller 80. Alternatively, any other suitable means of communication may be used to transfer the data to handheld device 80 including an RS232 port or infrared.

It is important to note that handheld 26 may incorporate a security component to prevent unauthorized use and reprogramming of a breaker. Such a security component may be a key or another apparatus. In another embodiment, the security means may be incorporated in the handheld firmware program (e.g., a secret code or password).

Turning now to FIG. 3, there is shown a flowchart illustrating the steps of the process of communication between handheld 26 and a desired breaker (breaker 18a). As the first step 120, a user must position handheld device 26 adjacent the desired circuit breaker (breaker 18a in this case), and power-on handheld device 26 to initiate communication. Execution moves to step 122 wherein handheld device 26 establishes electromagnetic communication with circuit breaker 18a. Broadly stated, a low frequency radio frequency signal is emitted (from handheld device 26) via antenna 86. The frequency is specifically chosen to correspond, i.e., to the activation frequency of RFID module 56. In this respect, breaker 18a need not be powered for reading and writing. The preferred RF frequency is 125 KHz. A low level frequency is used to require close proximity between handheld module 26 and breaker 18a to effect activation and the programming of the RFID module 56 (tag). Close proximity is also important to prevent activation and programming of unintended adjacent circuit breakers. The preferred proximity is 1 inch, but proper communication can be achieved with distances of 1.5 inches or less. As in any RFID module (tag), the distance (between handheld device 26 and breaker) is dependent on the diameter of the antenna used in the handheld device. (The distance between the controller and the RFID module (tag) is dependent on the antenna size and transmitter power). In short, the appropriate position of handheld 120 is required to ensure proper communication with (and only with) RFID module (tag) 56 within the desired circuit breaker. Other RFID modules with different frequencies can be use to achieve the same result.

In response to the emission of the appropriate RF signal, execution moves to step 124 wherein RFID module 56 (tag) is activated to enable reading and writing to tag 56. Following step 126, parameter data stored in memory 56a in RFID tag 56 is read and displayed on LCD 88 in steps 126 and 128 respectively. Because a cholesteric LCD is used, the last reading (image) is displayed even when power to handheld device 26 is either shut off or the lithium battery is depleted. Execution then moves to step 130 wherein the user selectively changes the parameters/settings in RFID module 56 (EEPROM 56a). That is, handheld device 26 transmits data to RFID module 56. The data is stored over existing parameter/setting data in RFID memory 56a in step 132.

It is important to note that one or more steps of steps 122, 124, 126, 130 are referred individually and together as the step of electromagnetically coupling handheld device 26 with circuit breaker 18a. In addition, the step of reading data (by handheld device 26) and/or the selective step of writing data are referred singularly to or in combination as the step of accessing the data in the RFID module 56 (tag).

FIG. 4 illustrates detailed steps of steps 122-126 shown in FIG. 3. In particular, microcontroller 80 within handheld device 26 generates a 125 KHz carrier wave, as shown in step 140. Following this step, transmitter 82a of radio module 82 modulates (amplitude) the carrier wave and transmits the resulting wave via antenna 86 in step 142. In that emitted wave, a command byte is sent over the modulated carrier wave to initiate communication with RFID module 56 (i.e., activate RFID module (tag) 56. This is step 144. In step 146, RFID module 56 in breaker 18a monitors for and activates upon receipt of the byte of data. In order to accomplish this step, the carrier wave is demodulated and data transmission is decoded to enable activation. Execution then moves to steps 148 and 150 wherein the parameter/setting data is then sent and such data is received via the carrier wave (value and prompts).

In steps 152 and 154 respectively, the RFID module (tag) data returned is demodulated by receiver 82b and decoded by microcontroller 80 to obtain the stored data. If changes to the data parameters/settings are desired, the user will select a desired new parameter (within the stored limitations and stepping rates in RFID memory 56a) on touch screen 84. The selected parameter/setting data will be transmitted similarly over the modulated carrier wave and stored in RFID memory 56a. The RFID module 56 will demodulate the carrier wave and decode the incoming transmissions from handheld device 26 similar to the decoding performed by the microcontroller 80 of handheld device 26. While the preferred embodiment described initially reads parameter/setting data from RFID memory 56a before any programming is performed, programming or writing may be accomplished without reading in other alternative embodiments.

With the preferred embodiment of the present invention, the switches of conventional breakers are eliminated along with the associated mechanical problems. This allows forensic examination of the settings even if the printed circuit board within the breaker has been partially destroyed. In addition, the number of openings in the breaker housing is reduced which reduces the amount of pollution and other contaminants from seeping into the breaker and affecting the printed circuit board. In addition, the breaker parameter/setting may be programmed in new buildings, long before power is applied. A field service operator may download and load new settings on site or at a field service center via a USB ports on the handheld device and PC. Further, the handheld device can setup multiple breakers with one or more setups. Also note that in the preferred embodiment, the display is remote from the breaker itself. Therefore, the LCD is not affected by the heat generated within the breaker. Consequently, the life of the LCD is increased.

The foregoing description of a preferred embodiment of the invention has been presented for purposes of illustration and description. It is not intended to be exhaustive or to limit the invention to the precise form disclosed and modifications and variations are possible in light of the above teachings or may be acquired from practice of the invention. The embodiment was chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and their equivalents.

What is claimed is:

1. A method of communicating with an electronic circuit breaker, the method comprising the steps of:
electromagnetically coupling a handheld device with the circuit breaker for communication therebetween; and
accessing data stored within the circuit breaker.

2. The method of claim 1 wherein the step of accessing comprises the step of reading the data stored within the circuit breaker.

3. The method of claim 1 further comprising the step of changing the data stored in the breaker.

4. The method of claim 1 wherein the step of electromagnetically coupling includes the step of transmitting an amplitude modulated carrier wave to carry data to and from the circuit breaker.

5. The method of claim 1 wherein the data includes a setting that is stored in an RFID module within the circuit breaker.

6. The method of claim 1 wherein the step of electromagnetically coupling the handheld device with the circuit breaker includes the step of selectively deriving power from the handheld device and a power supply within the breaker to enable the step of reading the data.

7. The method of claim 4 further comprises the step of demodulating data performed by the handheld device from the circuit breaker and decoding the demodulated data.

8. An electronic circuit breaker comprising:
an RFID component including an RFID module for storing data; and
a microcontroller connected to the RFID component and controlling the operation of the breaker in accordance with the data.

9. The circuit breaker of claim 7 wherein the RFID component includes an antenna coupled to the RFID module receiving a radio signal enabling the data stored in the RFID module to be read and reprogrammed.

10. The circuit breaker of claim 9 wherein the RFID module selectively derives power externally from the radio signal and power supply within the breaker.

11. The circuit breaker of claim 8 wherein the breaker is enclosed with a casing that enables RF communication with the RFID component within the breaker and provides a seal to prevent environmental contaminants from seeping into the breaker.

12. A handheld device for communicating with an electronic circuit breaker, the handheld device comprising:
a microcontroller controlling the operation of the handheld device; and
a communicating component connected to the microcontroller and communicating wirelessly with the electronic circuit breaker.

13. The handheld device of claim 12 wherein the communicating component includes an antenna receiving communication signals.

14. The handheld device of claim 12 wherein the microcontroller includes a storage device storing data relating to the operation of the circuit breaker.

15. The handheld device of claim 13 wherein the communication component includes a radio module coupled to the microcontroller and the antenna, the antenna adapted to transmit a radio signal for communicating with the circuit breaker.

16. The handheld device of claim 15 wherein the radio module is configured to transmit the data from the storage device to the circuit breaker.

17. The handheld device of claim 11 wherein the communicating component is configured to electromagnetically communicate with an RFID module within the circuit breaker, thereby enabling the access of data stored within the RFID module.

18. The handheld device of claim 11 further comprising a nonvolatile display for displaying data parameters.

19. A system for enabling the communication between a handheld device and a circuit breaker, the system comprising:
an electronic circuit breaker including an RFID component having an RFID module for storing data and a microcontroller connected to the RFID module and controlling the operation of the breaker in accordance with the data; and
a handheld device for communicating with the electronic circuit breaker, the handheld device including a microcontroller controlling the operation of the handheld device and a communicating component connected to the microcontroller communicating wirelessly with the electronic circuit breaker.

20. The system of claim 19 wherein the communicating component includes a radio module for transmitting an RF signal.
